(19) United States
(12) Patent Application Publication
(10) Pub. No.: US 2009/0004400 A1
(43) Pub. Date: Jan. 1, 2009

(54) Effect of Ternary Additions on the Structure and Properties of Coatings Produced by a High Aluminum Galvanizing Bath

(76) Inventors: Madhu Ranjan, Karnataka (IN); Raghvendra Tewari, Mumbai (IN); William J. van Ooij, Fairfield, OH (US); Vijay K. Vasudevan, Naperville, IL (US)

Correspondence Address: FROST BROWN TODD, LLC, 2200 PNC CENTER, 201 E. FIFTH STREET, CINCINNATI, OH, 45202, US

(21) Appl. No.: 10/597,231

(22) PCT Filed: Jan. 21, 2005
(86) PCT No.: PCT/US05/02032

§ 371 Date: Jul. 24, 2007

Related U.S. Application Data
(60) Provisional application No. 60/538,393, filed on Jan. 22, 2004.

(51) Int. Cl. B05D 1/18

(52) U.S. Cl. 427/437; 106/1.17

(57) ABSTRACT

A zinc-aluminum eutectoid galvanized steel has been developed. The basic composition of the bath is selected close to the eutectoid point in the binary Zn—Al system, together with ternary additions in the form of bismuth, rare-earths and silicon.

### INTRODUCTION

Improvement in corrosion resistance of steel products by coatings with zinc or its alloys is commonly known as galvanizing. Zinc provides corrosion resistance to steel by barrier protection as well as by galvanic protection. Zinc is less noble than iron and is preferentially attacked, thus protecting the base metal. Hot-dip-galvanized (HDG) coatings are applied by dipping the steel component in the molten zinc or its alloys either in a continuous manner or by a batch process. The coatings from a zinc bath are very adherent to the base metal because of the formation of the metallic bond between the base metal and zinc. These coatings, in general, consist of an overlay and an interfacial layer between the overlay and the substrate steel. The interfacial layer contains a series of intermetallic compounds which are brittle, and therefore detrimental to the formability of the coated steel.

The addition of aluminum in varying amounts to the galvanizing bath not only reduces the rate of leaching of zinc by providing an excellent barrier protection but also suppresses the formation and growth of the brittle iron-zinc intermetallic compounds. This is due to the formation of an inhibition layer at the substrate/coating interface, which is an Fe—Al phase with limited solubility for Zn. However, controlled growth of the Fe—Al based ternary intermetallics is important not only for control over coating thickness but also to improve the appearance of the coated surface.

Inhibition of Fe—Zn reactions is known to be transient, since Al delays the Fe—Zn reaction rather than suppressing it completely, and eventually Fe—Zn outbursts form. In order to delay the breakdown of the inhibition layer, and also to suppress the excess formation of the Fe—Al compounds, the high aluminum-containing zinc bath can be alloyed with ternary elements. Al provides very good barrier protection, and in combination with the excellent galvanic protection of Zn, galvanized products from Zn—Al baths such as Galfan® and Galvalume® provide corrosion protection several times better than that of Zn coatings.

The present application is directed to the use of small additions of alloy metals selected from the group consisting of Bi, rare-earth (RE) and/or Si, to a Zn—Al eutectoid galvanizing bath in order to affect the coating quality with respect to thickness, structure and corrosion properties of steel articles.

### SUMMARY OF THE INVENTION

The HDG coatings from a Zn—Al eutectoid galvanizing bath show a dense interfacial layer, a mixed phase intermediate layer and an overlay. The interfacial layer shows evidence of bursting at the metal/coating interface, and the intermediate layer exhibits a large number of porosities. The addition of Bi and RE as minor alloying elements do not appreciably change the coating morphology.

The coating thickness growth in a Zn—Al eutectoid bath remains linear on addition of Bi as well as RE (rare earth metals). However, the rate of growth tapers with Bi addition, and reduces to a greater extent on the addition of RE. The degree of the linear growth rate appears to be associated with the roughness of the coating surface, the porosities in the intermediate coating layer, and occurrence of bursting at the interface. The porosities nucleate around the trapped Al-oxide particles in the Zn-rich melt in the coating matrix, and appear proportional to the degree of the growth rate and occurrence of bursting at the metal/coating interface. An addition of about 0.2-0.4 wt % Si in the bath changes the interface-controlled linear growth to diffusion-controlled parabolic growth. A coating as thin as 10-40 μm can be achieved. The bursting at the interface, and the porosities in the intermediate layer are eliminated. The surface of the coated product appears bright and smooth.

The corrosion resistance of the coatings from the Zn—Al eutectoid galvanizing alloy is greater than that from the zinc galvanized coatings, and the minimum corrosion loss is observed in the case of smooth and dense coatings obtained from the Si treated bath.

### BRIEF DESCRIPTION OF FIGURES

FIG. 1: Graphs showing coating thickness as function time and temperature obtained from (a) Zn—22.3 wt % Al bath (b) Zn—22.3 wt % Al—0.1 wt % Bi bath; (c) Zn—22.3 wt % Al—0.3 wt % RE bath; and (d) Zn—22.3 wt % Al—0.3 wt % Si bath;

FIG. 2: Showing typical cross sectional microstructures of the coatings obtained from the four baths.

FIG. 3: SEM micrographs showing the interface layer obtained from the four baths; (a) Zn—22.3 wt % Al bath (b) Zn—22.3 wt % Al—0.1 wt % Bi bath (c) Zn—22.3 wt % Al—0.3 wt % RE bath and (d) Zn—22.3 wt % Al—0.3 wt % Si bath.

FIG. 4: Elemental map of the coatings produced by bath C and D. (a) Shows the distribution of Fe, Al and Zn in the coating from bath C; (b) Shows the distribution of Al, Fe, Zn and Si in the coating from bath D.

FIG. 5: Line scan obtained across the interface layer of the coating produced by bath C (bath temperature: 550° C., dipping time 80 s).

FIG. 6: Line scan obtained across the interface layer of the coating produced by bath D.

FIG. 7: Secondary electron image showing the presence of porosity in the intermediate layer.

FIG. 8: Secondary electron images showing the presence of eutectoid microstructure in the coatings produced by bath D; (a) lower magnified view of the coating (×2000) showed presence of gray and white regions marked as Bi and 62 in the micrograph.

FIG. 9: Micrographs showing the top layer (overlay) in samples from (a) bath A, (b) bath B, (c) bath C and, (d) bath D.

FIG. 10: XRD patterns obtained through-thickness of the coatings produced from bath D. (a) XRD from the coating surface; (b) XRD from intermediate layer (−10 um coating thickness); (c) XRD from intermediate layer (˜5 um coating thickness); (d) XRD from the interface layer (−2 um coating thickness) showing predominant presence of the Fe₂Al₅ phase along with Fe peaks which presumably were contributed from the substrate and traces of Zn.

FIG. 11: Corrosion resistance determined through measurement of polarization resistance (Rₚ) as a function of pH value of the electrolyte.

FIG. 12: (a) Binary Fe—Al phase diagram, (b) binary Zn—Al phase diagram, (c) isothermal section of ternary Fe—Al—Zn phase diagram at 575° C. and, (d) isothermal section of ternary Fe—Al—Si phase diagram at 600° C.

FIG. 13: EDS analysis of the top layer of the coating produced by bath C showing presence of rare-earth elements in this layer.

FIG. 14: Line scan obtained across the interface layer of the coating produced by bath C (temperature 530° C., dipping time: 40 s). The presence of Ce in the Zn rich phase can be concluded from this line scan.

### DEFINITIONS

Chemical composition of the experimental baths A-D used in this study:

| Bath | Additive | Al | Bi | La | Ce | Si |
|---|---|---|---|---|---|---|
| A | None | 22.1 | — | — | — | — |
| B | Bi | 22.1 | 0.10 | — | — | — |
| C | RE | 22.7 | — | 0.13 | 0.19 | — |
| D | Si | 22.2 | — | — | — | 0.3 |

### DETAILED DESCRIPTION OF THE INVENTION

The present invention relates to a Zn—Al based galvanizing bath, comprising small amounts of Bi, rare-earth (RE) and/or Si. In such a bath, the coating formed has three layers: (1) an interface layer; (2) an intermediate layer; and (3) an overlay. The coatings produced by the binary Zn—Al, Zn—Al—Bi and Zn—Al-RE are porous and show linear growth The coatings produced by Zn—Al—Si bath are non-porous and exhibit parabolic growth. Chemical analysis of different layers of coatings show that the interface layer is mainly composed of the Fe₂Al₅ phase, whereas the intermediate layer shows the presence of two phases—one rich in Al and the other rich in Zn. A depletion layer is observed only in the case of coatings produced by Zn—Al—Si bath. Most of the porosities are found to contain Al oxide. A eutectoid microstructure is observed in the case of coatings produced by Zn—Al—Si bath.

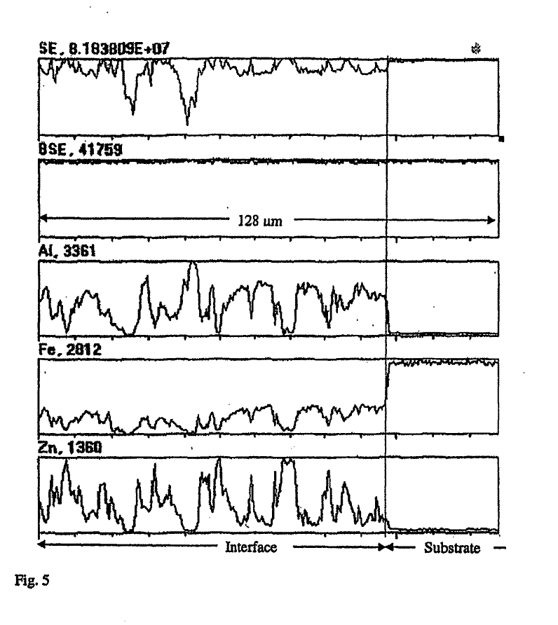

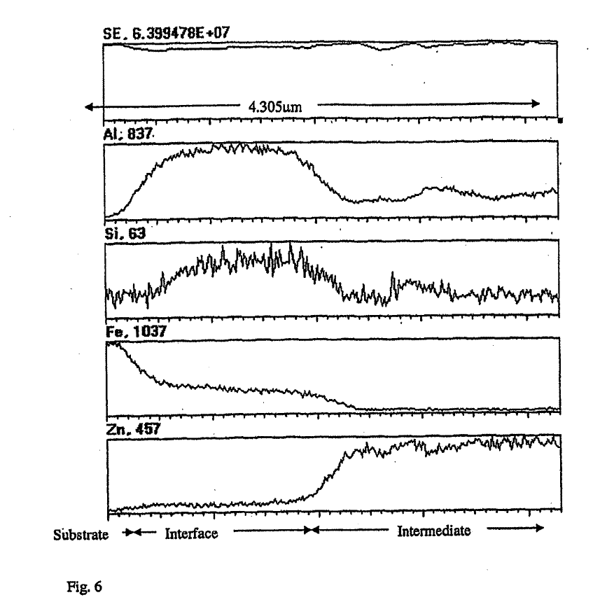

The coatings produced by these baths exhibit different growth rates and morphologies. The growth kinetics, however, are linear in all the cases except for the bath D which shows a parabolic growth. The line scan carried out across the interfacial layer does not show any depletion length for any element in the case of bath A, B and C (FIG. 5), indicating that the growth of the coatings are mainly interface controlled. In the case of the coatings produced by bath D, the presence of a depletion layer in the interface is observed indicating a diffusion-controlled growth process (FIG. 6). It is, therefore, pertinent to examine the interfaces in each of the coatings

### The Interface Layer

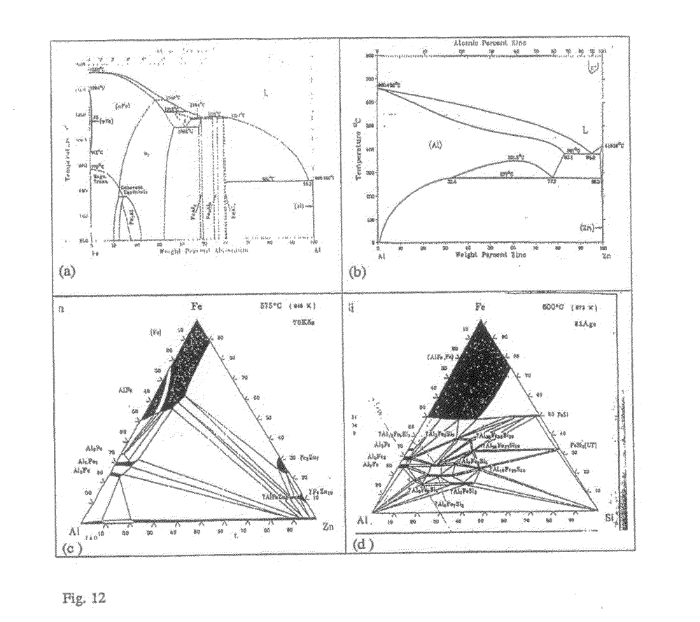

The chemical and XRD analysis of coatings in all cases shows that the interface layer (the layer next to the substrate), which is dense and coherent, is comprised mainly of ternary or quaternary derivatives of the binary Fe₂Al₅ intermetallic phase. The binary Fe—Al and Zn—Al phase diagrams and isothermal sections of the Fe—Al—Zn and Fe—Al—Si ternary phase diagrams are shown in FIG. 12. Note that: (i) the Fe₂Al₅ intermetallic phase has the highest liquidus temperature and therefore would be the first phase to solidify; and, (ii) it has low solubility for other elements. Based on this information it can be inferred that during the initial stages, the phase reaction is dominated by the formation of the Fe₂Al₅ intermetallic phase.

If the Al content in the bath exceeds 0.15 wt %, the Fe₂Al₅ becomes the thermally stable phase and under these conditions an extended solubility of Zn up to 22 wt % in the Fe₂Al₅ phase occurs. Since the formation of the FeZnAl₃ phase is not observed in the interface layer it may be concluded that the Fe₂Al₅ phase is directly formed from the liquid phase.

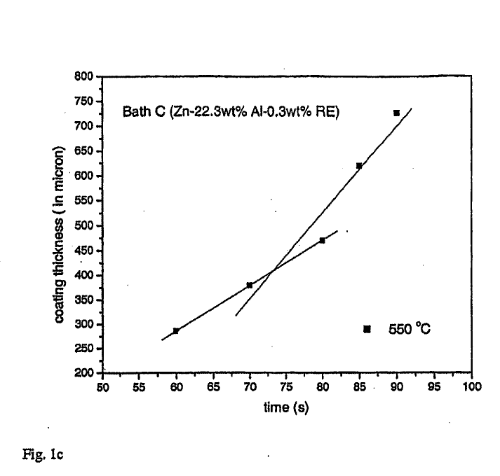

Based on an average Zn diffusion coefficient for the Fe₂Al₅ phase of 5×10⁻¹¹ cm²/s at around 460° C., the diffusion length {x≅(Dt)^{1/2}} of Zn in the Fe₂Al₅ phase should be in the range of 0.55 μm (60 s) to 0.95 μm (180 s). Not being bound by theory, based on this estimate, the lower concentration of Zn could be due to the fact that a high concentration of Al is present in the present experiments, which (i) reduce the relative concentration of Zn; and/or (ii) cause a more vigorous exothermic reaction between Fe and Al resulting in higher temperatures at the interface and hence faster diffusion of Zn from the Fe₂Al₅ phase, either towards the substrate or back to the bath. It is worth mentioning here that evidence of bursting has been noticed in the case of samples coated by bath A, B and C (FIG. 2) and the chemical composition of the burst region shows the presence of a high Zn concentration (Table 4). This suggests that diffusion of Zn occurs from the Fe₂Al₅ phase during the coating process.

Tang [N-Y: Met. Trans., 1995, vol. 26A, p. 1669] has shown that in dilute Al (<1 wt %) baths the formation of the Fe₂Al₅ phase is a two-step process. The first stage is associated with the uptake of Al, which is controlled by the continuous nucleation of the Fe₂Al₅ phase, and second stage is a diffusion controlled growth process of the Fe₂Al₅ phase. Again, not to be bound by theory, in the present application, since the concentration of Al is high (i.e., about 23 wt %), the availability of Al in the vicinity of the growing front should not be the controlling step. In contrast the lower concentration of Zn in the Fe₂Al₅ phase (Table 4) and the presence of a two-phase microstructure in the top portion of the interface layer suggests that probably the rejection of Zn from the Fe₂Al₅ phase is the rate-controlling step. Furthermore, the thickness of the interface layer determined for varying dipping time for bath C sample is found to be of the same order ranging between 60 to 180 μm with average of about 100 μm, whereas in the case of coatings produced by bath D the thickness of the interface layer is only about 4 μm. The negligible growth of the interfacial layer thickness during the dipping time of 60 to 120 s, as opposed to a three to six times growth of the intermediate layer, indicates that the growth of the dense interface layer stops at a certain level, after a rapid growth in the initial stages of the dipping.

### The Intermediate Layer

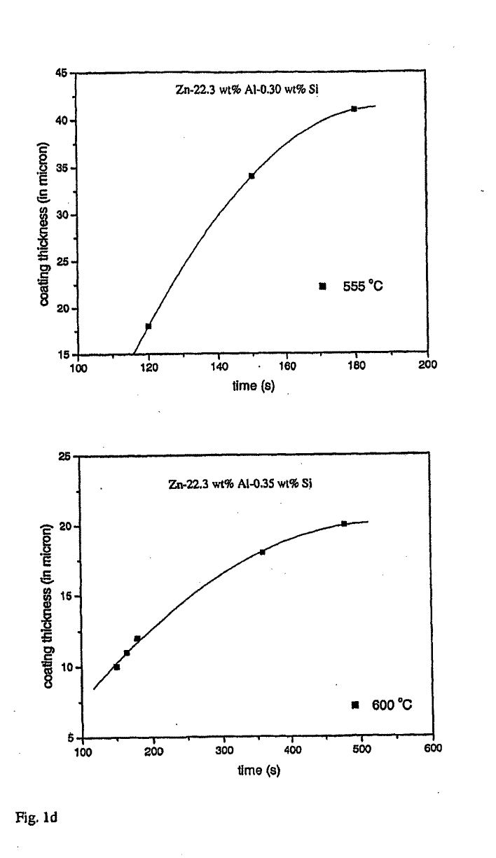

The intermediate layer has a multiphase microstructure (for example, FIG. 3). Strong solute partitioning between Fe, Al and Zn causes the formation of a Zn-rich phase and an Al (Fe)-rich phase. The morphology of this layer with the interface layer underneath indicates that the formation of the Fe—Al phase occurs first during the solidification process rejecting the excess of Zn. It appears that the formation of the intermediate layer starts when the concentration of Zn builds up ahead of the moving interface causing instability at the interface. In some of the regions the formation and growth of the Fe—Al phase continues the rejection of Zn into the inter-columnar space, causing the latter to become rich in Zn. The Zn-rich regions, having a lower liquidus temperature, remaining liquid at lower temperatures, thus solidifying the last. The composition of some of such Zn-rich areas has been found to approach the Zn—Al eutectic composition (FIG. 12b). The growth of the intermediate layer shows the presence of Fe bearing Al-rich phase. Without Si in the bath, the reaction zone flakes off, whereas with Si, the reaction zone is adherent. This solid reaction layer at the interface acts as a diffusion barrier for the reactive species, thereby reducing the reaction rate between the iron panel and the bath by several orders of magnitude as compared with the binary Al—Zn baths. Lower concentrations of Fe at the moving front retard the rate of formation of the phase, as Al shows high solubility of Fe under metastable conditions.

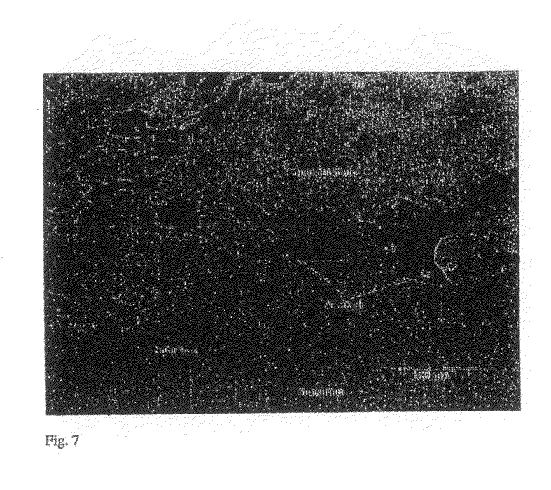

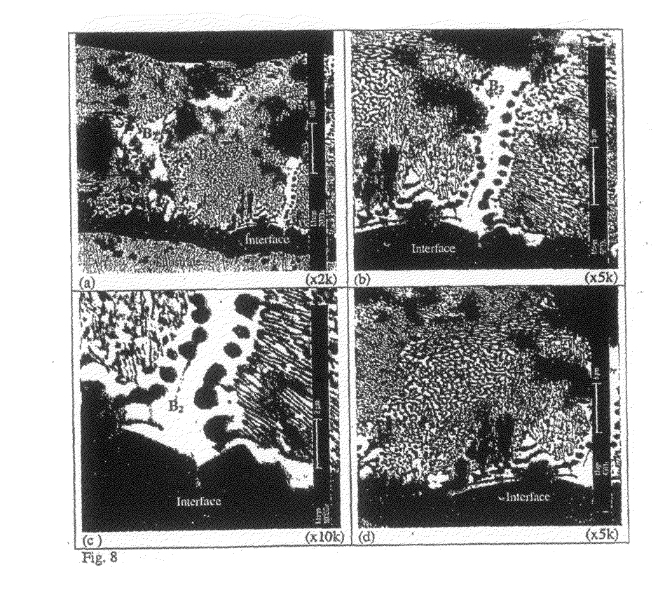

The slow growth of the Fe₂Al₅ phase allows other phases like Al-rich phase to start solidifying. The morphological evidence in support of this argument is: (i) the formation of Al-rich and the Zn-rich regions at the coarser level in the intermediate layer just ahead of the interface layer (FIG. 8a) indicating solute partitioning causing phase separation; (ii) the chemical composition of the Zn-rich regions being close to the eutectic composition indicate that the last phase to solidify had the lowest liquidus temperature.

The subsequent cooling of these phases has results in the formation of a lamellar structure indicating the occurrence of the eutectoid phase reaction.

The intermediate layers of the coatings produced by baths A, B and C show varying degrees of porosity with many of these porosities containing Al-oxide particles in the center, surrounded by a Zn-rich phase. The presence of Al-oxide particles in the middle of the porosities clearly indicates that the porosities formed from these particles. The oxide layer which forms at the top of the bath breaks-up when the steel panel is inserted into the bath, and small particles of these oxides may float around the substrate and become trapped in the Zn-rich phase, which remain liquid even when the sample is withdrawn from the bath. Subsequent solidification of such liquid phases would cause shrinkage resulting in development of high stresses between oxide particles and the matrix. The stresses cause separation of these particles from the matrix because the poor wettability of the oxide particles with the liquid phase minimizes the opportunity for any chemical bonding between them. The growth rates of the entire coating obtained from the bath A, B and C have shown a similar reducing trend indicating an interrelation between the porosity and the growth rate. The coating produced by bath D, containing Si, has a uniform two-phase microstructure in the intermediate layer. It does not show any porosity and at the same time it produces the lowest thickness. This also points toward the effectiveness of the alloying elements in controlling the growth as well as porosity of the coatings.

### Top Coating Layer

The drag-out layer of liquid metals, when the steel panel is withdrawn from the bath, is thicker when the bath viscosity is higher. Thus, lowering of bath viscosity, for example with Si addition, contributes towards a reduction in the coating thickness. The drag-out layer, also called overlay, solidifies on cooling to form the top coating layer which exhibits the bath chemistry. The top coating layer from bath D shows this phenomenon by exhibiting the Zn—Al eutectoid composition (Table 4). On the contrary, the reaction product is evident right up to the top of the coatings in the case of baths A, B and G, where some of the columnar growth of the Fe—Al—Zn ternary phase can be seen to continue from the intermediate phase up to the top of the coatings. The inter-columnar spaces were found filled with the Zn-rich phase. This indicates that the reaction between Fe and the drag-out molten bath continued even after the panel was withdrawn from the bath, probably facilitates heat generation due to the exothermic reaction between Fe and Al.

### Corrosion Behavior of the Coatings

There is an increasing order of corrosion resistance (Table 6) and decreasing order of porosity in the coatings from bath A, B and C, respectively (FIG. 2). The coating from bath D is completely free from porosity and shows the greatest resistance to corrosion. The correlation between the degree of porosity and corrosion property of the coating, is thought to be a result of a porous zinc oxide superficial layer which forms on the surface by a mechanism of dissolution/re-precipitation, leading to preferential corrosion pathways across the high porosity areas. Apart from the structural density, the Fe—Al—Zn alloy phase has superior corrosion resistance. The intermediate and the top coating layers from baths A, B and C exhibit predominantly Fe—Al—Zn intermetallics (darker phase) interspersed with a Zn-rich phase (brighter phase) where the Zn-corrosion products get trapped and act as further barrier to corrosion,

### Role of Ternary Additions

Ternary additions are carried out in the galvanizing bath with the aim of reducing the rate of growth of the coatings and arresting porosities. The quality of the coatings depends primarily upon the following factors:
The ease with which Fe and the reactive species from the bath diffuse towards each other through the interface layer;
Concentration of the oxides of Al in the bath which appears to control the porosity;
Viscosity of the liquid phase which reduces the overlay layer.
   A relatively higher concentration of Bi in the interface layer with bath B indicates that Bi has a moderate solubility in the Fe—Al intermetallics and a marginal reduction in the growth rate could be attributed to this fact. However, Bi is not very effective in controlling the diffusion of Fe, as the rate of growth remains linear throughout the coating process, indicating dominance of interface control growth. The main contribution of Bi is in reduction of viscosity of the liquid phase. The addition of 0.1 wt % Bi in the Zn bath reduces the surface tension from 550 to 475 mJ/m². Lower viscosity reduces the chances of entrapment of Al-oxide into the liquid phase, resulting in a lower porosity in the intermediate layer.

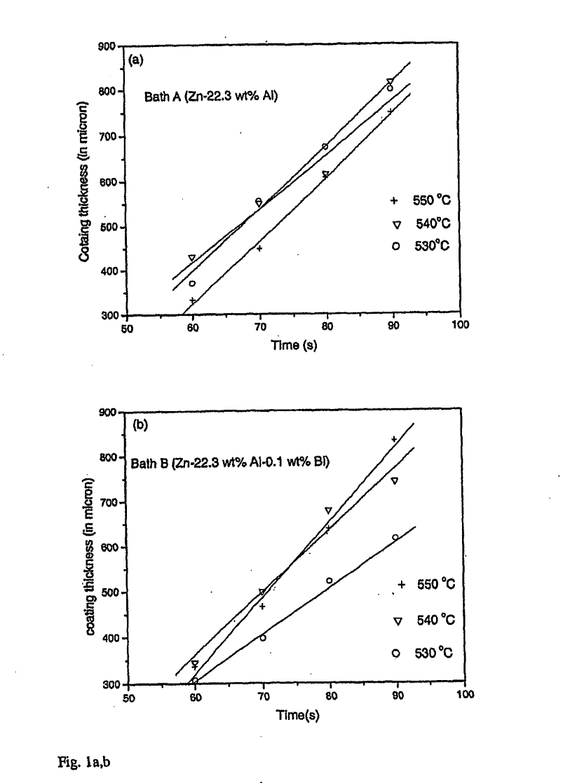

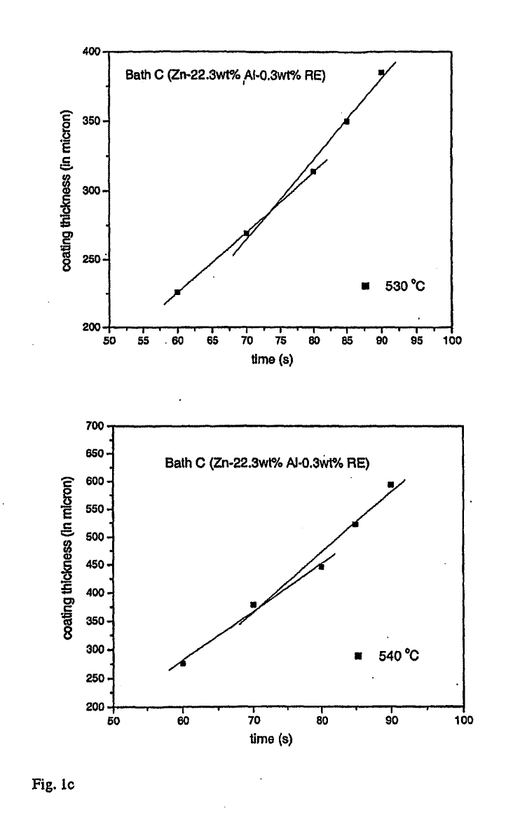

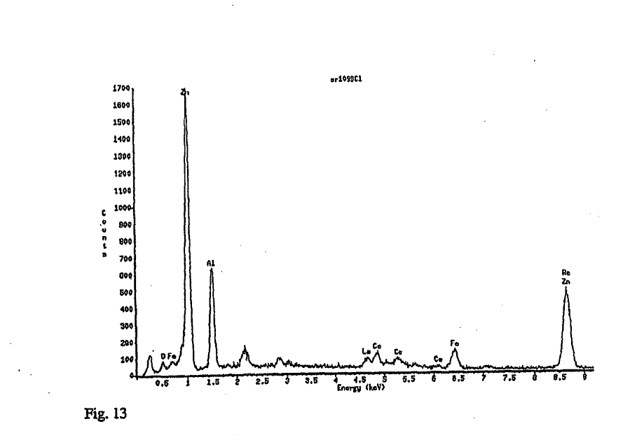

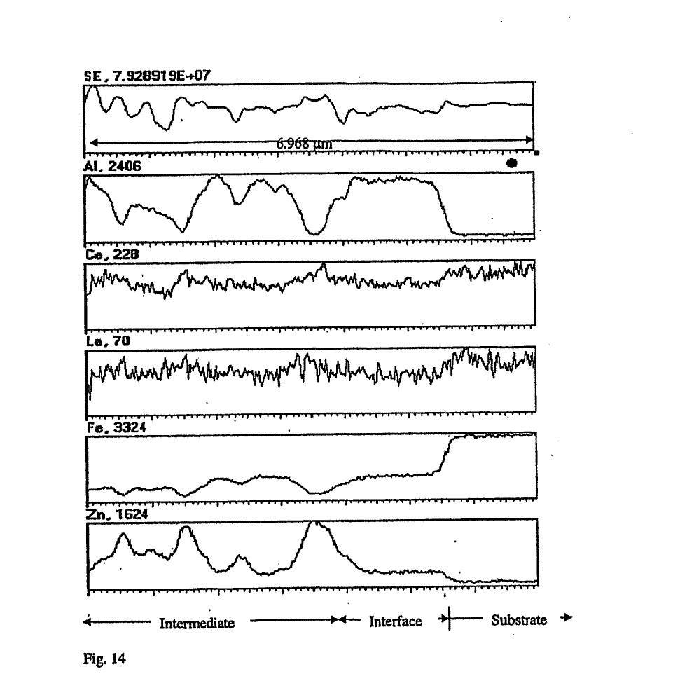

The role of the rare-earth elements appears to be more complicated, as these elements are not found in either the intermediate or the interfacial layer. However, these elements do occur at the top of the overlay layer (FIG. 13). The growth rates of the coatings have shown two types of behavior: a retarded growth rate in the initial stages and an accelerated growth in the later stages indicating presence of a break-off point (FIG. 1c). This effect is observed at all the temperatures, and the higher the temperature, the sharper is the change in growth rate. Apparently, the RE elements, due to limited solubility in the Fe—Al phase, are rejected into the bath or Zn-rich regions and hence the effects are worn-off in the later stages of coatings

Si is an effective ternary addition agent in the Zn—Al bath in terms of reduced coating thickness, uniformity of microstructure and corrosion resistance. The presence of a high concentration of Si in the interface layer indicate that along with Al, Si has also participates in the reaction. The beneficial role of Si can be attributed to the fact that it lowers the solidus temperature of the intermetallic compound and hence formation of the phase occurs at lower temperatures. This reduces the structural inhomogeneity due to smaller differential in solidification temperatures of the different phases. Si also reduces the diffusivity of solid Fe and the reactive species of the molten bath towards each other and hence retards the growth rate of coatings. Si also increases the bath fluidity and reduces the Al-oxide in the bath which minimizes the occurrence and entrapment of the Al-oxide particles in the bath, therefore yielding a coating free from porosities. These factors together reduce the thickness of the interface layer and also control the overall thickness of the coatings, which are free from porosities.

These thin, smooth and dense coatings exhibit excellent corrosion resistance. The thin coatings of about 20-30 μm are especially suitable for steel articles such as preformed threaded parts including, but not limited to, nuts and bolts.

### Experimental Procedures

### General:

Cold-rolled and annealed milled steel (Fe—0.08 C, 0.32 Mn, 0.008 P, 0.013 S, 0.010 Si and 0.047 Al) sheets with dimension of 125×50×1.6 mm are used for the galvanizing experiments. The steel panels are thoroughly cleaned in three stages: (i) ultrasonic acetone cleaning for 10 minutes; (ii) alkaline cleaning in NaOH solution at 70° C. for 10 minutes followed by scrubbing and rinsing in water; (iii) acid cleaning in dilute HCl at 50° C. for 1 minute, scrubbing and rinsing in water. Finally the samples are treated with a Cu-based flux, whose composition was 4-6% HCl, 3-5% SnCl₂, 0.1-0.25% CuCl₂-2H₂O. After fluxing, the panels were rinsed in water and dried prior to galvanizing under normal atmospheric condition.

The experimental galvanizing facilities include an electrically heated crucible furnace, SiC crucibles with a capacity of 3 kg of molten bath, a sample insertion machine and thermocouples. A eutectoid bath (Zn-22.3 wt % Al) is prepared for galvanizing (bath A). It was alloyed with: (i) 0.1 wt % Bi (bath B), (ii) 0.3 wt % of RE in the form of a master-alloy provided by Triebacher, Austria (bath C), and (iii) 0.2-0.4 wt % of Si in the form of Al—Zn—Si master alloy (bath D) (Table 1). The galvanizing temperature is varied between 530° C. and 60° C., and dipping time from 60 to 180 s. Experiments with bath A, B and C are repeated in a Rhesca galvanizing simulator under controlled reducing atmosphere to keep the metal are cleaned and deoxidized by pretreating at a temperature of 730° C. for 30 s under a reducing (N2+20% H₂) atmosphere, prior to galvanizing. The coatings developed here match in quality with those obtained under normal atmospheric laboratory conditions, hence the results obtained from bath A, B and C at the Rhesca simulator are reported here along with the results from bath D of the normal atmospheric laboratory conditions.

Coated samples are cut by a diamond blade, mounted and polished to study the through-thickness microstructure of the coatings in Hitachi S-3200M and Philips XL30-ESEM-FEG scanning electron microscopes (SEM). Energy dispersive spectroscopic (EDS) analysis, elemental mapping and elemental line scanning was conducted in Hitachi S-3200M and Hitachi S-4000 across the coating thickness. The process parameters of the representative samples investigated by SEM are given in Table 2.

The phases in the coating structure obtained with the bath D are analyzed using X-ray diffraction (XRD) patterns obtained at the Philips Analytical X-Ray B.V. The sample is exposed in the as-coated condition, and also after polishing-off part of the coatings to study the phases present at different depths of the coatings.

Coating thickness measurements are carried out using an Elcometer 300, Model A300FNP23, 0-1250 um range, on 20 locations on both faces of each coated sample. Their average is reported.

Field corrosion tests are conducted for 3 months at the Kure Beach, N.C. test site on the samples generated from all the above baths. Samples from two commercially produced grades of Zn-galvanized steels are also exposed for the purpose of comparison; one belonging to the more common galvanizing at 430° C. (herein called theta-galvanized) and the other galvanized at 500° C. (herein called delta-galvanized). Corrosion loss on field exposure is determined by washing away the products of corrosion from the surface of the coated products as per the ASTM Gl procedure; the samples are dipped in a 10 wt % ammonium persulfate solution for 30 minutes at room temperature, rinsed in running water and dried in air. This cleaning cycle is repeated six times. Three samples generated from each bath representing different dipping times are evaluated for corrosion loss and their average is reported.

Electrochemical corrosion test are carried out by determining the polarization resistance (Rₚ) on a Gamry Instruments' CMS 100 Corrosion Measurement System. A 3.5 wt % NaCl electrolyte is prepared with pH values of 3, 6.5 and 11 for this DC corrosion test. The Rₚ data generated on 12 samples from each galvanizing bath is averaged and presented here as a comparative corrosion resistance behavior.

### Experimental Results

### Coating Thickness

The coating thickness is measured as a function of bath temperature and dipping time. FIG. 1 summarizes the plots of the thickness of the coatings with time obtained from the experimental baths. A linear growth rate of the coating is observed in the case of bath A and bath B. The slope of growth rates at various temperatures are shown in Table 3. An increase in the slope with temperature is indicative of the increase of growth rate with temperature. The growth in the case of bath C shows a sharp change from a lower growth rate in the initial stages to a higher growth rate in the later stages, indicating a change in the mechanism of growth with passage of time. This also indicates that the initial beneficial effects of RE, reducing the coating thickness, is worn off in the later stages. The coatings obtained from bath D show a parabolic growth suggesting a stronger influence of Si on coating behavior as compared with the Bi or RE addition.

### Microstructures of the Coatings

Typical through-thickness microstructures of the coatings obtained from different bath compositions are shown in FIG. 2. The coatings exhibit three distinct layers which are designated as interface layer (marked as A), intermediate layer (marked as B), and overlay (marked as C). The interfacial layer of the coating is generally found to be very adherent. As can be noticed from these micrographs, the coatings obtained from bath A and B are very thick (−300-800 μm), and also contain porosities large in number and size (FIGS. 2a and b), whereas bath C showed a reduction in porosity (FIG. 2c) as well as in coating thickness (about 200 to about 700 μm). The overall coating thickness obtained from the baths A, B and C are an order greater than the prevalent industrial norm of about 80 μm. Besides higher thickness, the coatings produced by these baths are rough, dull in appearance and contain a high degree of discontinuities. In contrast, the coatings obtained from bath D are thin (˜30 μm), smooth and devoid of any porosity (FIG. 2d).

A closer examination of the substrate/coating interface of the samples from the baths A, B and C (FIG. 3a,b,c) shows random penetration of the reaction product into the substrate, which is indicative of the occurrence of bursting, whereas no such penetration was observed in the case of sample from the bath D (FIG. 3d). The occurrence and the effect of bursting is highlighted in FIG. 3b. Chemical analysis of this region (Table 4) indicates that the penetrating phase is an Fe—Al—Zn ternary phase having more Zn than elsewhere, and a Zn-rich unreacted pool of melt on the outer boundary of these bursts containing particles of the ternary Fe—Al—Zn phase. This phenomenon, though present in all the samples from baths A, B, and C, is especially pronounced in the case of bath B. A large compositional difference in these layers was noticed.

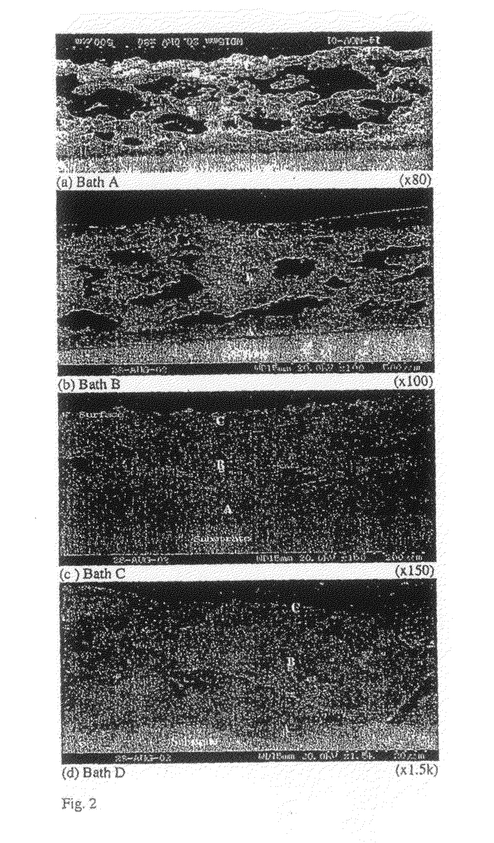

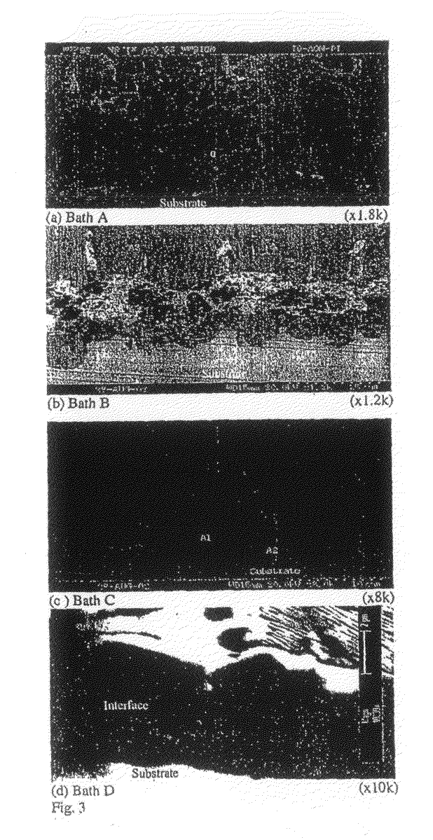

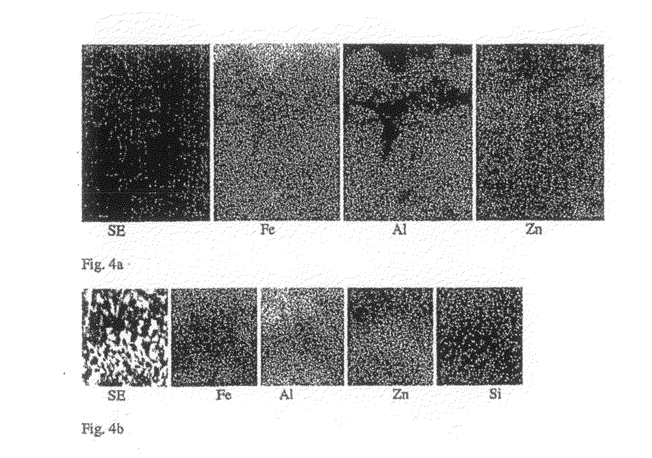

The thickness of the interfacial layer does not show an appreciable change on increasing the dipping time (from 70 to 90 s), at a given temperature (550° C.) for bath C (Table 5), suggesting that, though the total coating thickness increased appreciably, the dense interfacial layer does not grow beyond a certain thickness. The interface, which appears as a dark-grey, dense and homogenous layer next to the substrate is found rich in Fe and Al and lean in Zn in all cases. Table 4 summarizes the chemical composition of different regions. FIG. 4a shows elemental distribution in the intermediate layer across the columnar growth in the sample from bath C. The dark columns are found rich in Fe and Al, and the bright areas are Zn-rich. The elemental distribution in the intermediate layer of the sample from bath D is shown in the FIG. 4b. Fe and Al appear together everywhere with minor presence of Si, whereas Zn makes a contrast.

The distribution of elements across the interface can best be illustrated by representing the elemental concentrations in the form of a line scan. The sample from bath C (FIG. 5) shows a homogeneous mix of an Fe—Al phase rich in Al, and a Zn-rich phase. It can be noticed from this scan that (i) the peaks of Al and Fe coincide whereas the peaks of Zn are in contrast with these elements, (ii) and there is no evidence of depletion of the elements across the interfacial layer. Spot analysis shows that the composition of the Fe—Al phase is close to Fe₂Al₅ (with Zn substituting for Al). The line-scan for bath D sample (FIG. 6), however, exhibits depletion of Si and Fe across the interfacial layer. The quantitative analysis of the interface layer shows the presence of bismuth and silicon in bath B and D respectively, whereas bath C does not show any presence of RE in this layer (Table 4), or even in the intermediate layer.

Chemical analysis of several porosities indicates that many of them contained aluminum oxide particles in the center surrounded by a zinc-rich phase (FIG. 7).

The coating produced by bath D, on the other hand, does not show any porosity. The intermediate layer in bath D sample, on coarser level, shows the presence of a two-phase nicrostructure, where a few bright melt-like regions appear in a predominantly gray phase (FIG. 8a). The gray phase (marked as BD in FIG. 8a) shows a composition close to Al-rich phase, whereas the bright phase, appearing like a flowing melt morphology (marked as 62 in FIG. 8a), is found to have a composition close to the Zn—Al eutectic point with negligible presence of Fe and Si (Table 4, D2). Upon magnifying the gray regions (marked as BI) a well developed lamellar structure is revealed (FIG. 8b, c, d). Such morphology suggests the formation of the eutectoid microstructure in this region.

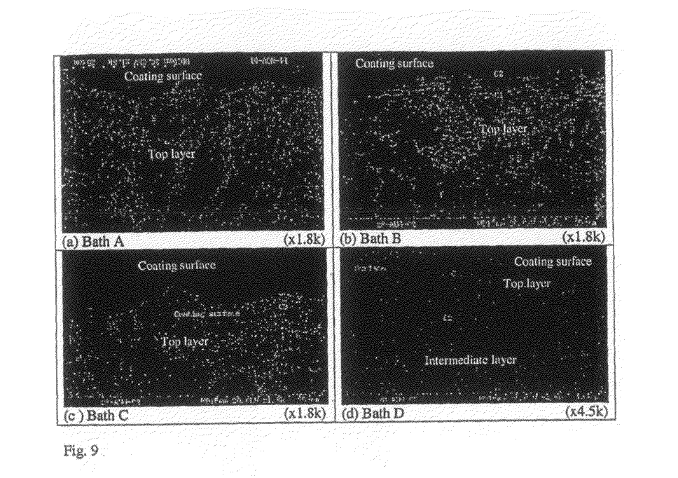

Some of the columns can be seen to grow up to the top layer of the coatings in the samples from bath A, B and C (FIG. 9), and the inter-columnar gaps appear filled with the Zn-rich phase. The bath D sample show an overlay having an overall Zn—Al eutectoid composition (Table 4).

### X Ray Analysis of Phases Encountered in the Coating

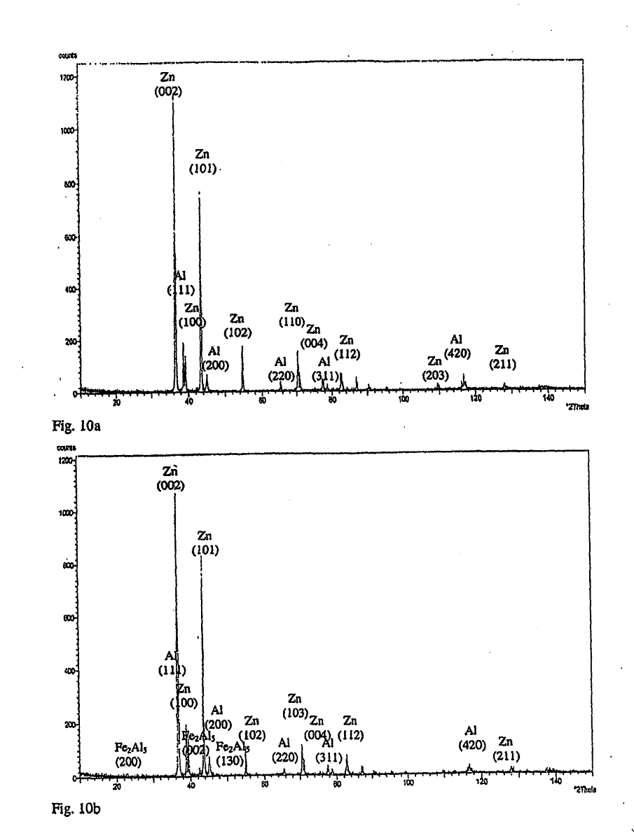

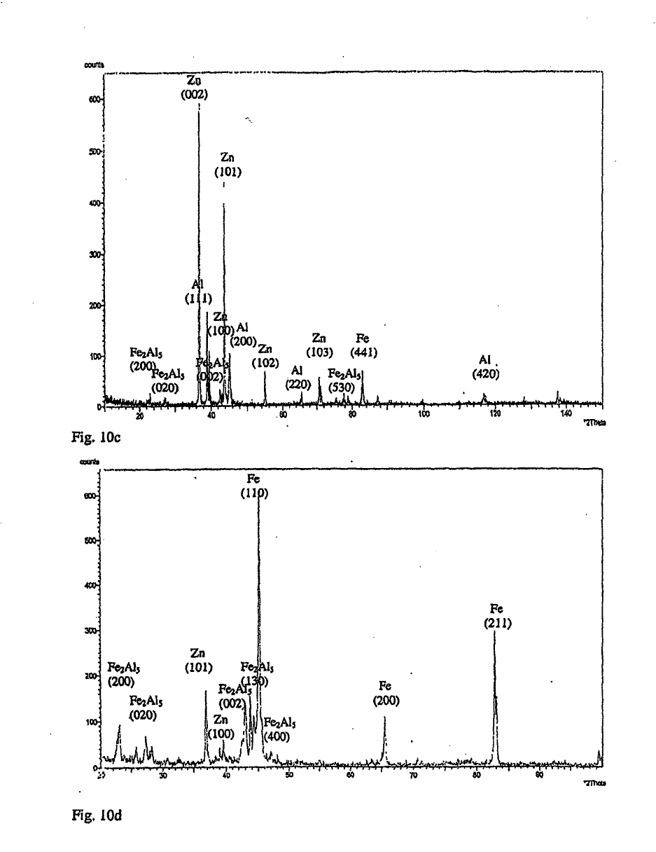

Through thickness XRD patterns obtained from various regions of coatings, from the surface down to the interface, show the presence of various phases. The top surface of coating obtained from bath D shows the presence of Zn and Al only (FIG. 10a). In the intermediate layer (at a coating thickness of about 10 um) the presence of the Fe₂Al₅ phase, along with the Al and Zn phases is observed (FIG. 10b). Near the interfacial layer (at a coating thickness of about 5 um), the presence of relatively stronger peaks of the Fe₂Al₅ phase indicate increasing volume fraction of this phase in regions close to interface layer (FIG. 10c). Finally, in the interface layer (at a coating thickness of 2 um) the presence of the Fe₂Al₅ phase is observed (FIG. 10d). The presence of Fe-peaks in this XRD pattern may be the result of exposure of the substrate at some places.

### Corrosion Studies

Corrosion loss on field exposure at Kure Beach is found, on an average, to be 4.8, 3.1, 1.9 and 1.0 mils per year (mpy) for galvanized steel samples generated from baths A, B, C and D, respectively (Table 6), whereas it is 7.7 and 5.5 mpy for the commercially produced theta and delta galvanized steel samples, respectively. The galvanized samples from all the Zn—Al eutectoid baths, therefore, exhibit superior corrosion resistance compared with the conventional Zn-bath galvanizing, and among the various Zn—Al eutectoid baths studied, that containing Si yield the best results.

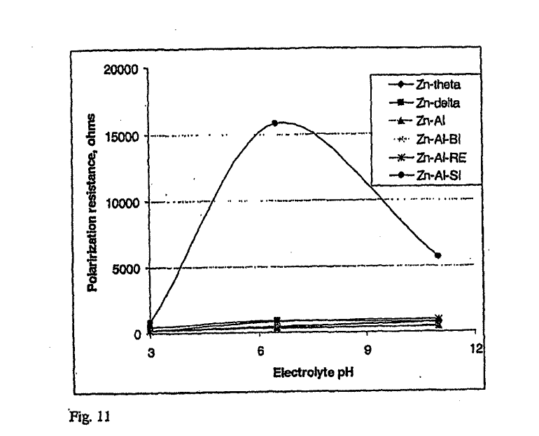

The polarization resistance (Rₚ), which is inversely proportional to the current density (i_{Corr}) provides a quick measure of the corrosion properties. The greater the value of Rₚ the higher would be the resistance against corrosion. The polarization resistance curves (FIG. 11) indicate that addition of Bi and RE does improve the Rₚ values, and hence the corrosion resistance, of the coatings developed from the Zn—Al eutectoid bath to some extent but it is not a substantial improvement over that of the commercial zinc-galvanized steel. On the other hand, the coatings from the Si-treated bath show about fifteen times greater resistance to corrosion as compared with the commercially produced Zn-galvanized steel at normal atmospheric conditions of pH=6, as well as at higher pH of 11. In acidic condition of pH=3, all the samples show a lower resistance to corrosion.

TABLE 1
Chemical composition of the experimental baths used in this study

| Bath | Additive | Al | Bi | La | Ce | Si |
|---|---|---|---|---|---|---|
| A | None | 22.1 | — | — | — | — |
| B | Bi | 22.1 | 0.10 | — | — | — |
| C | RE | 22.7 | — | 0.13 | 0.19 | — |
| D | Si | 22.2 | — | — | — | 0.3 |

TABLE 2
Process parameters of the samples selected
for microstructural investigation.

| Sample # | Bath | Additive | Bath Tempf C.) | Dip Time(s) |
|---|---|---|---|---|
| 1 | A | None | 530 | 80 |
| 2 | B | Bi | 540 | 80 |
| 3 | C | RE | 540 | 80 |
| 4 | D | Si | 590 | 120 |

TABLE 3
Coating thickness growth rate for the experimental baths

| | Linear behavior, slope of the curve | | | | Nonlinear behavior | |
|---|---|---|---|---|---|---|
| | u, m/s | | | | ‘y = tⁿ; n’ | |
| | | | Zn—Al-RE | | Zn—Al—Si | |
| Temperature (° C.) | Zn—Al | Zn—Al—Bi | Initial stage | Later stage | 0.03 Si | 0.035 Si |
| 530 | 11.9 | 10.14 | 4.4 | 5.8 | 0.48 (555 | 0.58 (600 |
| 540 | 13.9 | 13.74 | 8.55 | 10.75 | | |
| 550 | 14.07 | 16.66 | 9.2 | 17.4 | | |

TABLE 4
Chemical analysis of coating layers as per EDS

| | Fe | | Al | | Zn | | Bi | | Re | Si | | |
|---|---|---|---|---|---|---|---|---|---|---|---|---|
| Bath | wt % | at % | wt % | at % | wt % | at % | wt % | at % | % | wt % | at % | Remarks |
| | Interfacial layer | | | | | | | | | | | |
| A | 46.5 | 40.0 | 19.7 | 35.1 | 33.8 | 24.9 | — | — | — | — | — | Bursting |
| B | 46.4 | 35.5 | 30.1 | 47.6 | 18.3 | 11.9 | 3.6 | 0.7 | — | — | — | Bursting |
| c • | 57.6 | 45.8 | 23.4 | 38.4 | 17.7 | 12.0 | — | — | — | — | — | Bursting |
| D | 43.3 | 29.4 | 43.1 | 60.6 | 10.8 | 6.3 | — | — | — | 2.8 | 3.8 | Fe₂Al₅ |
| | Intermediate layer (Dark gray phase) | | | | | | | | | | | |
| A | 23.8 | 21.0 | 19.8 | 36.3 | 56.5 | 42.7 | — | — | — | — | — | |
| B | 35.1 | 30.2 | 24.8 | 44.2 | 24.4 | 17.9 | 14.1 | 3.2 | — | — | — | |
| C | 30.5 | 22.3 | 31.5 | 47.7 | 34.7 | 21.7 | — | — | — | — | — | |
| D | 30.0 | 21.7 | 30.2 | 45.3 | 33.3 | 20.6 | — | — | — | 3.9 | 5.6 | |
| | Intermediate layer (Brighter phase) | | | | | | | | | | | |
| B | 4.4 | 4.7 | 3.8 | 8.5 | 84.9 | 77.8 | 4.8 | 1.4 | — | — | — | |
| C | 2.9 | 3.0 | 2.9 | 6.3 | 92.0 | 82.5 | — | — | — | — | — | |
| D, | 0.9 | 0.8 | 19.2 | 36.4 | 79.6 | 62.3 | — | — | — | 0.3 | 0.5 | Eutectoid |
| D₂ | 0.8 | 0.9 | 4.7 | 10.7 | 94.3 | 88.0 | — | — | — | 0.2 | 0.4 | Eutectic |
| | Top Layer (Dark gray phase) | | | | | | | | | | | |
| A | 30.9 | 25.3 | 26.3 | 44.6 | 42.9 | 30.1 | — | — | — | — | — | |
| B | 41.0 | 28.9 | 39.7 | 57.8 | 12.9 | 7.8 | 4.5 | 0.8 | — | — | — | |
| C | 27.1 | 21.3 | 27.2 | 44.3 | 43.8 | 29.4 | — | — | — | — | — | |
| | Top layer (Brighter phase) | | | | | | | | | | | |
| B | 7.1 | 7.0 | 7.7 | 15.7 | 79.7 | 67.1 | 2.8 | 0.7 | — | — | •— | |
| C | 5.9 | 5.9 | 8.4 | 17.4 | 84.4 | 72.2 | — | — | — | — | — | |
| D | 2.4 | 1.9 | 22.9 | 39.3 | 72.1 | 51.1 | — | — | — | — | — | Eutectoid |
| | Porosity: Particles and the surrounding bright phase | | | | | | | | | | | |
| | Fe | | Al | | Zn | | Oxygen | | Re | Si | | |
| Bath | wt % | at % | wt % | at % | wt % | at % | wt % | at % | % | wt % | at % | Remarks |
| C | 0.5 | 0.2 | 56.1 | 44.8 | 3.8 | 1.1 | 40.1 | 53.9 | — | — | — | Particle |
| c 1 | 5.4 | 4.6 | 26.8 | 46.6 | 67.8 | 48.8 | — | — | — | — | — | Vicinity |

TABLE 5
Growth of coating layers with time in bath C at 550° C.

| | Total | | | | |
|---|---|---|---|---|---|
| Dipping | Thickness, | Interfacial layer thickness, urn | | | Growth Beyond |
| Time, s | \hat{ }m | Min | Max | Average | Interface, urn |
| 70 | 379 | 67 | 135 | 95 | 284 |
| 80 | 470 | 68 | 139 | 100 | 370 |
| 90 | 727 | 63 | 154 | 114 | 613 |

TABLE 6
Corrosion losses on field exposure

| | Corrosion loss, mpy | | |
|---|---|---|---|
| Bath | Min | Max | Average |
| Zn-theta (Standard HDG) | 7.24 | 8.11 | 7.67 |
| Zn-delta (High temperature HDG) | 4.82 | 6.12 | 5.47 |
| A | 3.45 | 5.09 | 4.82 |
| B | 1.87 | 4.25 | 3.08 |
| C | 1.65 | 2.02 | 1.85 |
| D | 0.64 | 1.28 | 0.96 |

What is claimed is:

1) A Zn—Al eutectoid hot-dip galvanizing bath for stainless steel, where the galvanizing bath further comprises an alloy metal selected from the group consisting of Bi, rare-earth metals (RE's) or Si.

2) The Zn—Al galvanizing bath of claim 1 wherein the concentration of aluminum is from about 22.1% w/w to about 22.7% w/w.

3) The Zn—Al galvanizing bath of claim 2, wherein the concentration of the alloy metal is from about 0.1% w/w to about 0.4% W/W.

4) The Zn—Al galvanizing bath of claim ˜3, wherein the alloy metal is bismuth in a concentration of about 0.1% w/w.

5) The Zn—Al galvanizing bath of claim 3, wherein the alloy metals are rare earth metals at a total concentration of about 0.3% w/w.

6) The Zn—Al galvanizing bath of claim 5, wherein the rare earth metals consist of La at a concentration of about 0.13% w/w and Ce at a concentration of about 0.19% w/w.

7) The Zn—Al galvanizing bath of claim 3, wherein the alloy metal is Si in a concentration of about 0.3% w/w.

8) The Zn—Al galvanizing bath of claim 2 having a temperature of about 530° C. to about 600° C.

9) The Zn—Al galvanizing bath of claim 8, wherein the dip time for such a bath is from about 60 to about 180 seconds.

10) A hot-dipped galvanized steel coating comprising:
a) an interface layer comprising binary Fe₂Al₅;
b) an intermediate layer comprising a multiphase microstructure and consisting of a phase rich in Al and a phase rich in Zn; and
c) an overlay layer.

11) The hot-dipped galvanized steel coating of claim 10, wherein the coating is selected from the group consisting of Zn—Al, Zn—Al—Bi, Zn—Al-RE and Zn—Al—Si mixtures, and the concentration of the Bi, RE or Si is from about 0.1% w/w to about 0.4% w/w.

12) A process hot-dip galvanization of a steel article comprising the steps of:
(a) forming a Zn—Al galvanizing bath, wherein the concentration of the aluminum is from about 22.1% w/w to about 22.7% w/w;
(b) adding an alloy metal to the galvanizing bath;
(c) heating the bath to a temperature of about 530° C. to about 600° C.;
(d) galvanizing said steel article by dipping it in the bath for a period of about 60 seconds to 180 seconds.

13) The process of claim 12 where the alloy metal is selected from the group consisting of Bi, rare-earth metals (RE's) or Si.

14) The process of claim 13 wherein the RE's are La and Ce.

15) The process of claim 14 where the alloy metal is in a concentration of about 0.1% w/w to about 0.4% w/w.
